(19) United States
(12) Patent Application Publication
(10) Pub. No.: US 2021/0248708 A1
(43) Pub. Date: Aug. 12, 2021

(54) SYSTEM FOR CONCESSION, MERCHANDISE, AND SPONSORED WAGERS

(71) Applicant: AdrenalineIP, Washington, DC (US)

(72) Inventors: Casey Alexander HUKE, Washington, DC (US); John CRONIN, Jericho, VT (US); Joseph BODKIN, Quincy, MA (US); Harrison GRANT, Anaheim, CA (US)

(73) Assignee: AdrenalineIP, Washington, DC (US)

(21) Appl. No.: 17/085,131

(22) Filed: Oct. 30, 2020

Related U.S. Application Data
(60) Provisional application No. 62/972,121, filed on Feb. 10, 2020.

(51) Int. Cl. G06Q 50/34; G07F 17/32

(52) U.S. Cl. CPC G06Q 50/34; G07F 17/323; G07F 17/3288; G07F 17/3253; G07F 17/3237

(57) ABSTRACT

An exemplary embodiment includes a data management and analytic statistical software system/wagering platform in which users can place wagers in order to win prizes from game day sponsors such as swag, merchandise, or items from the concessions. In addition, the sponsor can sweeten the deal on a bet by paying the “vig” or house take, improving the odds, matching an amount wagered, and the like. Advertisers may condition these improvements on viewing an ad or engaging with sponsored content. Deals between the sponsor and the offeror of the bet may take the form of affiliate advertising. Advertisers can show bettors how much more they made or how much less they had to wager due to the advertiser's influence. Swag or merchandise may also include coupons.

### FIELD

The exemplary embodiments may be generally related to sports betting and smart phone applications

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Micro event betting has become more popular and is largely being facilitated by the efficiency of smart phones. One problem is how to advertise directly to the micro bettor market.

Another problem is that since micro events take place during a macro event, there are options available to micro event betting that would not be useful to macro event betting and are not being utilized by the current market.

Advertisers who want to reach micro event bettors or move merchandise need a system in place to identify targeted users and bets before the macro event because micro event betting is face-paced and real-time.

### SUMMARY

A method for wagering through a graphical interface. The method may include identifying a macro event with more than one potential outcome, identifying a micro event with more than one potential outcome within the macro event, presenting betting options and odds to a user through a graphical user interface based on the more than one potential outcome of the micro event, allowing one or more sponsor to alter the betting options or odds, receiving bets on the altered betting options, receiving the outcome of the micro event, and crediting the bettor based on the outcome of the micro event and received bet if the bettor won the bet, with a monetary and/or a non-monetary reward.

### BRIEF DESCRIPTIONS OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a concession, merchandise, and sponsored wagers, according to an embodiment.

FIG. 2 illustrates a bet database, according to an embodiment.

FIG. 3 illustrates a prize database, according to an embodiment.

FIG. 4 illustrates a sponsor database, according to an embodiment.

FIG. 5 illustrates a base module, according to an embodiment.

FIG. 6 illustrates a bet module, according to an embodiment.

FIG. 7 illustrates a prize module, according to an embodiment.

FIG. 8 illustrates a sponsor module, according to an embodiment.

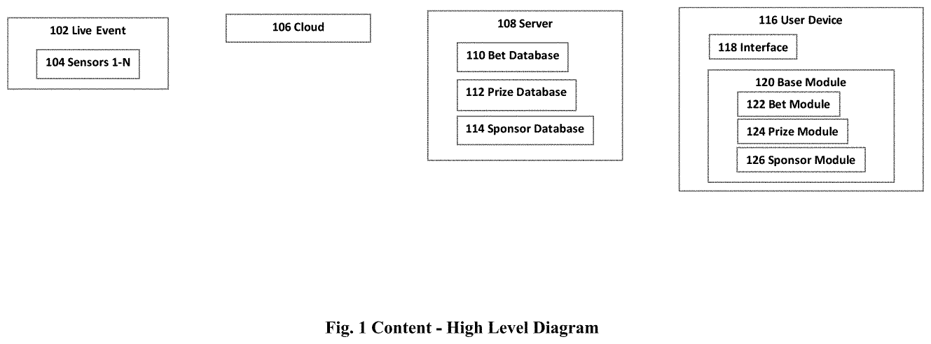

### DETAILED DESCRIPTION

This is a system for a concession, merchandise, and sponsored wagers. This system includes a live event 102, for example a sporting event such as a football game, basketball game, baseball game, hockey game, tennis match, golf tournament, eSports or digital game, etc. The live event 102 will include some number of actions or plays, upon which a user, bettor, or customer can place a bet or wager, typically through an entity called a sportsbook. There are numerous types of wagers the bettor can make, including, but not limited to, a straight bet, a money line bet, a bet with a point spread or line that bettor's team would need to cover, if the result of the game with the same as the point spread the user would not cover the spread, but instead the tie is called a push. If the user is betting on the favorite, they are giving points to the opposing side, which is the underdog or longshot. Betting on all favorites is referred to as chalk, this is typically applied to round robin, or other styles of tournaments. There are other types of wagers, including, but not limited to, parlays, teasers and prop bets, that are added games, that often allow the user to customize their betting, by changing the odds and payouts they receive on a wager. Certain sportsbooks will allow the bettor to buy points, to move the point spread off of the opening line, this will increase the price of the bet, sometimes by increasing the juice, vig, or hold that the sportsbook takes. Another type of wager the bettor can make is an over/under, in which the user bets over or under a total for the live event 102, such as the score of American football or the run line in baseball, or a series of action in the live event 102. Sportsbooks have an amount of bets they can handle, a limit of wagers they can take on either side of a bet before they will move the line or odds off of the opening line. Additionally, there are circumstances, such as an injury to an important player such as a listed pitcher, in which a sportsbook, casino or racino will take an available wager off the board. As the line moves there becomes an opportunity for a bettor to bet on both sides at different point spreads in order to middle and win both bets. Sportsbooks will often offer bets on portions of games, such as first half bets and half time bets. Additionally, the sportsbook can offer futures bets on live events in the future. Sportsbooks need to offer payment processing services in order to cash out customers. This can be done at kiosks at the live event 102 or at another location.

The system may include a number of sensors 104 that may be used such as motion sensors, temperature sensors, humidity sensors, cameras such as an RGB-D Camera which is a digital camera providing color (RGB) and depth information for every pixel in an image, microphones, radio frequency receiver, a thermal imager, a radar device, a lidar device, an ultrasound device, a speaker, wearable devices etc. Also, the sensors 104 may include tracking devices, such as RFID tags, GPS chips or other such devices embedded on uniforms, in equipment, in the field of play, in the boundaries of the field of play, or other markers on the field of play. Imaging devices may also be used as tracking devices such as player tracking that provides statistical information through real-time X, Y positioning of players and X, Y, Z positioning of the ball. The system also includes a cloud 106 or communication network which may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

The cloud 106 may be communicatively coupled to server 108 which may perform real time analysis on the type of play and the result of the play. The cloud 106 may also be synchronized with game situational data, such as the time of the game, the score, location on the field, weather conditions, and the like which may affect the choice of play utilized. For example, in other exemplary embodiments, the cloud 106 may not receive data gathered from sensors 104 and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

The system may include a server 108 which may perform real time analysis on the type of play and the result of a play or action. The server 108 (or cloud 106) may also be synchronized with game situational data, such as the time of the game, the score, location on the field, weather conditions, and the like which may affect the choice of play utilized. For example, in other exemplary embodiments, server 108 may not receive data gathered from sensors 104 and may, instead, receive data from an alternative data feed, such as SportsRadar. This data may be provided substantially immediately following the completion of any play and the data from this feed may be compared with a variety of team data and league data based on a variety of elements, including down, possession, score, time, team, and so forth, as described in various exemplary embodiments herein.

The server 108 can offer a number of software as a service managed services such as, user interface service, risk management service, compliance, pricing and trading service, IT support of the technology platform, business applications, game configuration, state based integration, fantasy sports connection, integration to allow the joining of social media, as well as marketing support services that can provide engaging promotions to the user. A bet database 110 contains the options that users can place a bet on, for example run or pass, and the associated odds of each option occurring. The bet database 110 also contains which options the users have already placed bets on. In some embodiments the available options for a bet and the actual user bets may be stored in separate databases. The system may include a prize database 112 that contains a list of prizes that may be won via betting in addition to or in lieu of a monetary value. For example, the reward for a winning bet may be a t-shirt or coupon for a free hotdog instead of cash or credit. Alternatively, the cash or credit payout may be reduced and awarded alongside the other prize instead of replaced. A sponsor database 114 stores settings for sponsors who would like to sponsor bets. Sponsors may opt to pay the “vig” for a bet or may simply agree to increase the payout for winning bets in order to advertise directly to the users.

A user device 116 such as a computing device, laptop, smartphone, tablet, computer, smart speaker, or I/O devices. I/O devices may be present in the computing device. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers. Devices may include a combination of multiple input or output devices, including, e.g., Microsoft KINECT, Nintendo Wiimote for the WIT, Nintendo WII U GAMEPAD, or Apple IPHONE. Some devices allow gesture recognition inputs through combining some of the inputs and outputs. Some devices provide for facial recognition which may be utilized as an input for different purposes including authentication and other commands. Some devices provides for voice recognition and inputs, including, e.g., Microsoft KINECT, SIRI for IPHONE by Apple, Google Now or Google Voice Search.

Additional devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices, display devices or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also provide storage and/or an installation medium for the computing device. In still other embodiments, the computing device may provide USB connections (not shown) to receive handheld USB storage devices. In further embodiments, an I/O device may be a bridge between the system bus and an external communication bus, e.g. a USB bus, a SCSI bus, a FireWire bus, an Ethernet bus, a Gigabit Ethernet bus, a Fibre Channel bus, or a Thunderbolt bus. The user device 116 can leverage the sensors 104 for purposes such as automatic content recognition, augmented reality or the synchronization of screens between the user device interface and other displays. The interface(s) 118 may either accept inputs from users or provide outputs to the users, or may perform both the actions. In one case, a user can interact with the interface(s) using one or more user-interactive objects and devices. The user-interactive objects and devices may include user input buttons, switches, knobs, levers, keys, trackballs, touchpads, cameras, microphones, motion sensors, heat sensors, inertial sensors, touch sensors, or a combination of the above. Further, the interface(s) 118 may either be implemented as a Command Line Interface (CLI), a Graphical User Interface (GUI), a voice interface, or a web-based user-interface. A base module 120 initiates the bet module 122, prize module 124, and sponsor module 126. A bet module 122 accepts the user's bet selection. A prize module 124 offers the user a chance to alter the reward for a winning bet to include a non-monetary prize such as a t-shirt or coupon for concessions. In some embodiments the user may choose a prize to bet on before selecting a bet. A sponsor module 126 may display a sponsored message or advertisement and may allow the user to see how the sponsor has altered the bet payout, prizes, or vig.

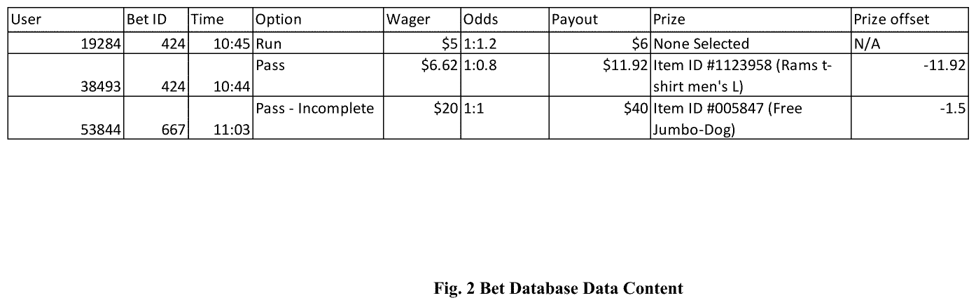

Functioning of the bet database 110 will now be explained with reference to FIG. 2. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the bet database 110. The database 110 contains the options that users can place a bet on, for example run or pass, and the associated odds of each option occurring. The odds may be known, calculated by another module, or retrieved from a third party. The bet database 110 also contains which options the users have already placed bets on along with the payout amount if they win, the money wagered, and any prize options. The database 110 may contain a price offset which determines how much to subtract from the monetary winnings if a prize is awarded in lieu of or in addition to monetary winnings. In some embodiments the available options for a bet and the actual user bets may be stored in separate databases. User betting data can be used to inform future bet odds.

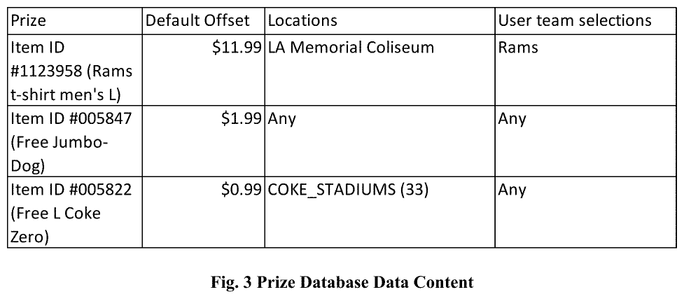

Functioning of the prize database 112 will now be explained with reference to FIG. 3. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the prize database 112. The database 112 contains a list of prizes that may be won via betting in addition to or in lieu of a monetary value. For example, the reward for a winning bet may be a t-shirt or coupon for a free hotdog instead of cash or credit. Alternatively, the cash or credit payout may be reduced and awarded alongside the other prize instead of replaced. An exemplary default prize offset is the amount to be subtracted from the monetary winnings when a prize is selected may be stored in the database. The default may be altered, for example, to move product, entice users to bet, or based on a sponsorship deal. Other data like restrictions on location and user targeting may be stored in the database 112.

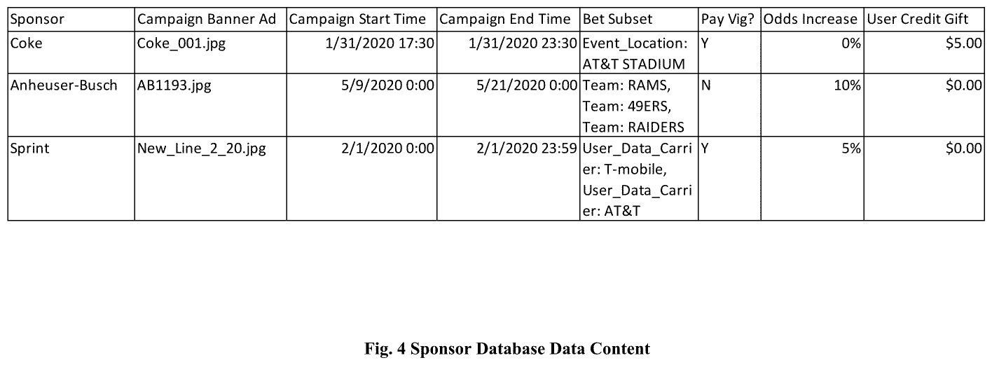

Functioning of the sponsor database 114 will now be explained with reference to FIG. 4. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the sponsor database 114. The database 114 contains settings for sponsors who would like to sponsor bets. Sponsors may opt to pay the “vig” for a bet or may simply agree to increase the payout for winning bets in order to advertise directly to the users. Sponsors may choose to effect bets for specific teams, events, players, or some other subset of bets for a specified amount of time. Sponsors may also make bets more appealing in other ways, for example, giving the user an amount of credits to make bets with, creating a leaderboard for users based on bet winnings, giving out sponsored prizes, matching some percent of a user's bet, etc.

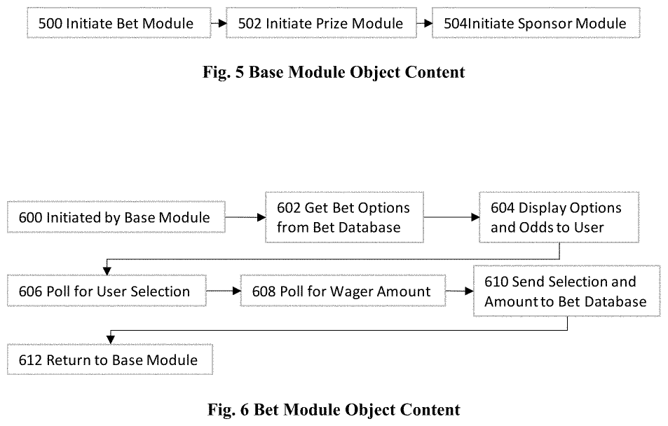

Functioning of the base module 120 will now be explained with reference to FIG. 5. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the base module 120. The process begins with the base module 120 initiating the bet module 122 for using wager data which will retrieve the bet options from the bet database 110 on the server 108 for the current play data of the game. Play data can be any sensor data that indicates anything about the live game, such as, but not limited to audio or visual data that indicates “actions”, “sides”, “event” data, “total” data, “listed pitchers”, specific players, whistles, fouls, touchdowns, goals, yardage, player error, etc. Wager data can be a “Bet” or “wager” or “buy points” or “price” or “no action” or “favorite” or “chalk” or “circled game” or “laying the points price” or “dog” or “underdog” or “money line” or “straight bet” or “straight-up” or Line” or “cover the spread” or “cover” or “tie” or “pick” or “pick-em” or “middle” or “parlay” or “round robin” or “teaser” or “prop bet” or “first-half-bet” or “half-time-bet” or “futures bet” or “future” or “Handle” or “juice” or “vigorish” or “off the board, at step 500. The base module 120 initiates the prize module 124 which will retrieve the available prizes from the prize database 112 on the server 108 and display those prizes to the user or offer a prize at some point in the betting process to entice the user to bet, at step 502. The base module 120 initiates the sponsor module 126 which will retrieve the sponsor settings from the sponsor database 114 on the server 108, display the sponsor's ad if there is one, and make changes to the betting options based on sponsor settings, for example, the cost of betting, betting payout or available prizes. It should be noted that the base module 120 can be made available for access, reconfiguration, modification, or control for “customers” or used for “Managed service user interface service”, “Managed service risk management services”, “Managed service compliance service”, “Managed service pricing and trading service”, “Managed service and technology platform”, “Managed service and marketing support services”, “Payment processing services”, “Engaging promotions”, “Customized betting” “Business Applications”, “State based integration”, “Game Configurator”, “Fantasy sports connector”, “Software as a service”, “Synchronization of screens”, “Automatic content recognition (ACR)”, “Joining social media”, and “Augmented reality”, at step 504.

Functioning of the bet module 122 will now be explained with reference to FIG. 6. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the bet module 122. The process begins with the bet module 122 being initiated by the base module 120, at step 600. The bet module 122 retrieves the possible options to bet on for the current play, quarter, game, or other unit of a sports game, along with the associated odds for the likelihood of that outcome, from the bet database 110 on the server 108, at step 602. The bet module 122 displays the bet options and odds to the user and allows the user to select a bet to make, at step 604. The bet module 122 polls the user's bet selection, when the user makes a bet selection the bet module 122 prompts the user for a wager amount, at step 606. The bet module 122 polls for the user's wager amount, and in some embodiments the bet module 122 will calculate the payout for each wager value the user enters before accepting a finalized wager submission from the user, at step 608. The bet module 122 sends the user's bet option and wager amount to the bet database 110 on the server 108, and in some embodiments there may be a warning or check that the user needs to respond to before the bet is finalized, at step 610. The bet module 122 returns to the base module 120, at step 612.

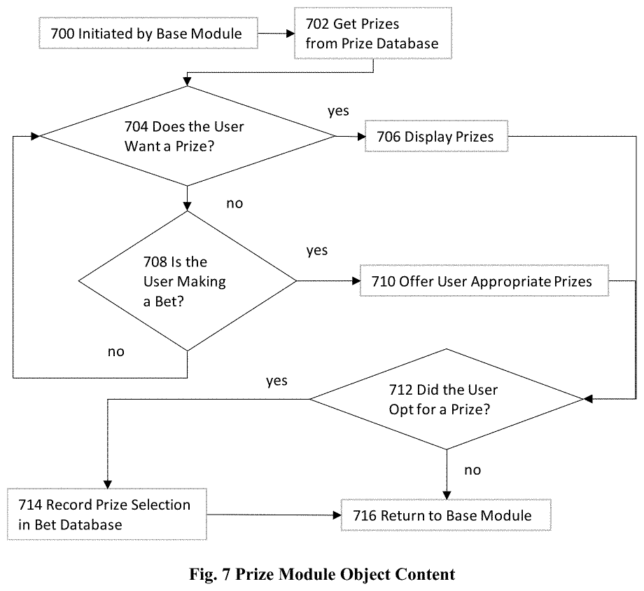

Functioning of the prize module 124 will now be explained with reference to FIG. 7. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the prize module 124. The process begins with the prize module 124 being initiated by the base module 120, at step 700. The prize module 124 retrieves the available prizes from the prize database 112 on the server 108, some prizes may only be available at certain locations, times, events, or for certain users, the prize module 124 only retrieves the prizes that are available given the conditions, for example, users at a stadium with Pepsi products would not be eligible to receive a prize of a large Coke product, at step 702. The prize module 124 determines if the user has indicated they want a prize, this may be done by having a button or link within the application which may be labeled as “Win a Prize” or “View Prizes”, or the user may have certain settings that indicate they prefer prizes to cash or credit payouts, at step 704. If the user has indicated they want a prize, the prize module 124 displays some or all of the prizes available. In some embodiments, the prizes may be tied to a specific bet option or set of bet options. In an embodiment, the user may select a prize to see what they would have to wager on each bet option in order to win the prize, at step 706. If the user has not indicated they want a prize, the prize module 124 determines if the user is making a bet, in an embodiment if the user has indicated they do not want a prize the prize module 124 returns to the base module 120 here, or alternatively is never initiated by the base module 120, the prize module 124 continues to check if the user is making a bet or wants a prize until the answer to one of those questions is positive or until returning to the base module 120, at step 708. If the user is making a bet, the prize module 124 determines which prizes would be appropriate to offer in lieu of all or some of the payout, and what is appropriate may be determined by comparing the payout to the default offset value in the prize database 112, for example if the user's bet would have a payout of $10, the prize module 124 may offer the user a payout of $9 and a free hot dog voucher, but would not offer the user the chance to win a free car because the value of a car is substantially more than $10, in an embodiment, the prize module 124 may offer a prize to entice the user to increase their wager. For example the prize module 124 could prompt the user to increase their wager by $10 and receive a free hot dog, at step 710. The prize module 124 determines if the user opted to win a prize in lieu of or in addition to a monetary payout, at step 712. If the user opted to win a prize, the prize module 124 may record that prize with the associated bet in the bet database 110 on the server 108, at step 714. The prize module 124 returns to the base module 120, at step 716.

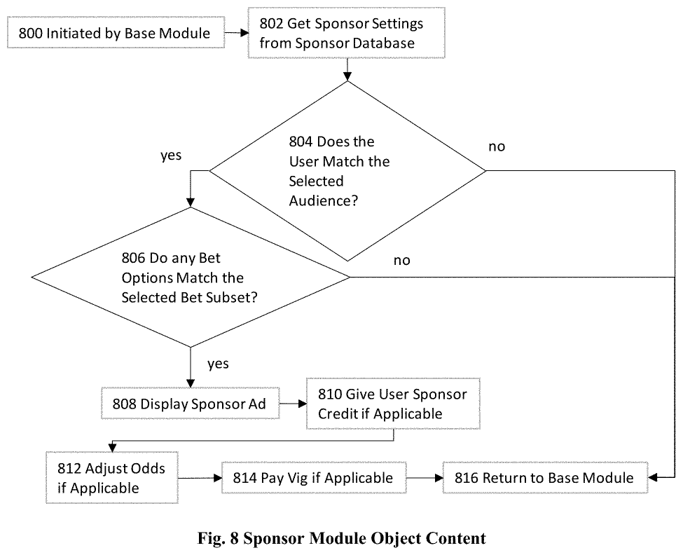

Functioning of the sponsor module 126 will now be explained with reference to FIG. 8. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

This figure displays the sponsor module 126. The process begins with the sponsor module 126 being initiated by the base module 120, at step 800. The sponsor module 126 retrieves the sponsor settings from the sponsor database 114 on the server 108, at step 802. The sponsor module 126 determines if the user is a member of the selected audience the sponsor intends to reach. This may mean the user is in the selected proximity of an event, that the user is a fan of a specific team or teams, or other information that allows the sponsor to tailor advertisements to their target market. If the user is not part of the selected audience, the sponsor module 126 returns to the base module 120, at step 804. If the user is part of the selected audience, the sponsor module 126 determines if at least one of the bet options matches the subset of bets that the sponsor intends to affect. For example, a sponsor may choose only to better the odds of bets on passes but not runs, or the sponsor may match up to a dollar on bets that are in favor of the home team. If none of the bet options are part of the selected bet subset, the sponsor module 126 returns to the base module 120. In another embodiment, the sponsor module 126 continues to poll until at least one bet option is part of the selected bet subset, at step 806. If the user is part of the selected audience and at least one bet option is part of the selected subset. The sponsor module 126 displays the sponsor's ad to the user if the sponsor has provided one, at step 808. If the sponsor has chosen to give users credit, the sponsor module 126 will give those users credit and indicate that the credit is from the sponsor. Credit may be given once or multiple times and may require the user to view or interact with an advertisement, at step 810. If the sponsor has chosen to adjust the odds in favor of users, the sponsor module 126 will apply the adjustment. In an exemplary embodiment the user will be shown the adjusted and unadjusted odds and the difference will be attributed to the generosity of the sponsor, at step 812. If the sponsor has chosen to pay the vig, and there is a vig, then the user will not have to pay the vig. In an exemplary embodiment, the user would be made aware that the sponsor is paying the vig on their behalf, at step 814. The sponsor module 126 returns to the base module 120, at step 816.

1. A method for wagering on an action in real time, comprising:
identifying a macro event with more than one potential outcome;
identifying a micro event within the macro event, the micro event having more than one potential outcome;
presenting betting options and odds based on the more than one potential outcome of the micro event;
allowing one or more sponsors to alter at least one betting option; and
receiving a bet wagered on the at least one altered betting option.

2. The method of claim 1, wherein, if the reward comprises both a monetary and a non-monetary reward, a monetary value of the non-monetary reward is subtracted from the monetary reward.

3. The method of claim 1, wherein the one or more of the sponsors pays for the bet.

4. The method of claim 1, further comprising identifying a plurality of available non-monetary rewards, wherein a non-monetary reward is selected from the plurality of available non-monetary rewards.

5. The method of claim 1, further comprising receiving an outcome of the micro event; and
crediting a bet based on the outcome of the micro event if the bet is successful with a reward.

6. A system for wagering, comprising:
a bet database, a prize database, and a sponsor database; and
a user terminal provided at a user location, comprising a bet module, a prize module, and a sponsor module;
wherein the system is configured to identify one or more live events available for wagering, each of the one or more live events associated with a physical location;
wherein the bet module is configured to identify one or more micro-events within each of the one or more live events and is configured to populate the bet database with a plurality of wagering options based on the one or more micro-events identified by the bet module;
wherein the prize module is configured to identify one or more available prizes from the prize database, each of the one or more available prizes comprising a non-monetary prize, and is configured to associate the one or more available prizes with the one or more micro-events, each of the prizes further associated with eligibility information;
wherein the sponsor module is configured to receive sponsor settings from the sponsor database and is configured to identify one or more relevant sponsors, and is configured to modify, based on the relevant sponsors, one or more of the wagering options; and
wherein the system is configured to determine, on the user terminal, based on an identification of the user location and comparison of the user location to the eligibility information, one or more user-eligible prizes in the one or more available prizes, and providing, on the user terminal, a selection option to receive a portion of payout in the form of a prize selected from the one or more user-eligible prizes.

7. The system of claim 6, wherein the one or more relevant sponsors are identified based on a user location.

8. The system of claim 6, wherein the one or more relevant sponsors are identified based on a target audience.

9.-10. (canceled)

11. The system of claim 6, wherein the wager options are modified to increase the odds in favor of a bettor.

12. The system of claim 6, wherein the available prizes are identified based on a bet amount.

13. The system of claim 6, wherein the one or more available prizes include one or more of food, apparel, team memorabilia, and beverages provided at a specific venue associated with the user location.

14. A computer implemented method for wagering through a graphical interface, comprising executing on a processor the steps of:
displaying a betting game interface;
displaying one or more live events, the one or more live events comprising one or more micro-events; and
displaying one or more sponsored wagers, wherein the sponsored wagers are altered by a sponsor to include a reward.

15. The computer implemented method of claim 14, wherein the additional reward is a non-monetary prize.

16. The computer implemented method of claim 14, further comprising identifying relevant sponsored wagers based on a user information, wherein the displayed sponsored wagers are selected from the relevant sponsored wagers.

17. The system of claim 6, wherein the one or more relevant sponsors are determined based on one or more interactions between a user and the one or more relevant sponsors via the user terminal.

18. The system of claim 17, wherein the one or more interactions comprises displaying, on the user terminal, an advertisement, and determining if the user has watched the advertisement.

19. The system of claim 6, wherein the eligibility information further comprises an association with a specific team, and wherein the system is configured to determine the one or more user-eligible prizes based on a favored team of the user matching the specific team.

20. The system of claim 6, wherein the eligibility information further comprises an association with a specific team, and wherein the system is configured to determine the one or more user-eligible prizes based on the specific team participating in a live event at the user location.
